(19) United States
(12) Patent Application Publication
(10) Pub. No.: US 2018/0116457 A1
(43) Pub. Date: May 3, 2018

(54) COOKING MANAGEMENT DEVICE EQUIPPED WITH A COOKING VESSEL RECOGNITION SYSTEM

(71) Applicant: SEB S.A., ECULLY (FR)

(72) Inventors: Claire MILLS, Annecy (FR); Thierry GAILHARD, Chaponnay (FR)

(21) Appl. No.: 15/561,839

(22) PCT Filed: Mar. 24, 2016
(86) PCT No.: PCT/FR2016/050666

§ 371 Date: Sep. 26, 2017

(30) Foreign Application Priority Data
Mar. 27, 2015 (FR) 1552639

(51) Int. Cl. A47J 37/10; A47J 45/06; A47J 45/07; H05B 3/68; H05B 6/12

(52) U.S. Cl. CPC A47J 37/108; A47J 45/068; H05B 2213/06; H05B 3/68; H05B 6/1209; A47J 45/071

(57) ABSTRACT

A food cooking management device configured to be removably positioned on a cooking vessel cooperating with a hot plate, the cooking management device being configured to emit signals intended either to control the hot plate or to prompt the user to act on the hot plate and/or on the food being cooked, wherein the cooking management device includes a recognition system to recognize a type and/or size of the cooking vessel on which the cooking management device is positioned, said recognition system acting on the cooking management device in order to adapt the signals emitted according to the type and/or size of the cooking vessel recognized.

This invention concerns a food cooking management device intended to be removably positioned on a cooking vessel cooperating with a hot plate, the cooking vessel being in particular a frying pan, a saucepan, a Dutch oven or a pressure cooker. The invention also concerns a set including at least one cooking vessel and a cooking management device.

From the document U.S. Pat. No. 6,860,192, we are aware of a food cooking management device intended to be removably positioned on a cooking vessel, in particular a frying pan, cooperating with a hot plate. The cooking management device is designed to emit signals intended to control the hot plate. The user may adjust the cooking management device to the size of the frying pan by manually acting on an interface in order to adapt the signals emitted according to the size of the cooking vessel. However, such a cooking management device obliges the user to check carefully, when fitting it onto a cooking vessel, that it is properly configured for the right size of cooking vessel used. Otherwise, the signals emitted during cooking will not be adapted to the size of the vessel and the cooking result will not be as desired.

The goal of this invention is to remedy the aforementioned drawbacks and to propose a cooking management device which makes it possible to guarantee the food cooking result, in particular by presenting improved ergonomics.

Another goal of the invention is to propose a cooking management device with reliable, repetitive, long-lasting operation.

Another goal of the invention is to propose a cooking management device that has a simple design and is economical to use.

These goals are achieved with a cooking management device intended to be removably positioned on a cooking vessel cooperating with a hot plate, the cooking management device being designed to emit signals intended either to control the hot plate or to prompt the user to act on the hot plate and/or on the food being cooked, characterized in that the cooking management device includes a system to recognize the type and/or size of the cooking vessel on which it is positioned, said recognition system acting on the cooking management device in order to adapt the signals emitted according to the type and/or size of the cooking vessel recognized.

“A cooking management device intended to be removably positioned on a cooking vessel” is understood to mean that the cooking management device can easily be separated from the cooking vessel by the user, without the need to use a tool.

“Said recognition system acting on the cooking management device in order to adapt the signals emitted according to the type and/or size of the cooking vessel recognized” is understood to mean that at minimum, the signal emitted by the cooking management device corresponds to the type and/or the size of the cooking vessel that will be processed by a device external to the cooking management device, in particular a control device for a hot plate which adapts the heating power according to the type and/or size of the vessel recognized.

The cooking management device autonomously recognizes the type and/or the size of the cooking vessel on which it is positioned. Thus, the signals emitted by the cooking management device are always adapted to the type and/or size of the cooking vessel recognized. Consequently, the signals emitted are reliable and the food cooking result is guaranteed.

Advantageously, the recognition system includes a memory in which is stored a table including value ranges of a characteristic of the cooking vessel, each value range being associated with a type and/or size of cooking vessel, and the recognition system is designed to detect a value of the characteristic of the cooking vessel and to deduce from it the type and/or the size of the cooking vessel on which it is installed based on the value ranges stored in the memory, said characteristic being in particular an electrical and/or mechanical and/or optical characteristic.

Each value range stored is associated with a type and/or size of cooking vessel. When the recognition system detects a value of a characteristic of the cooking vessel which falls within a value range, the cooking management device deduces from this the type and/or the size of the cooking vessel associated with this value range.

Thus, the cooking management device identifies the type and/or the size of the cooking vessel in a reliable manner.

“Said characteristic being an electrical characteristic” is understood to mean that the recognition system detects a characteristic chosen from among a resistance value, a voltage, an intensity or a capacity.

Preferably, it includes a radio transmitter, in particular a Bluetooth® transmitter, in order to emit the signals intended either to control the hot plate or to prompt the user to act on the hot plate and/or act on the food being cooked.

Such an arrangement makes it possible to obtain a wireless cooking management device that can easily be installed successively on different cooking vessels.

Advantageously, the management device may cooperate with a remote terminal, in particular a smartphone which receives the signals intended to prompt the user to act on the hot plate and/or on the food being cooked.

Advantageously, it includes a display and/or audio means in order to prompt the user to act on the hot plate or on the food being cooked.

Such an arrangement makes it possible to obtain a cooking management device equipped with a particularly economical interface to display information prompting the user to act on the hot plate or on the food being cooked. Audio means, in particular a buzzer, advantageously supplement the visual information displayed.

Advantageously, the display shows an icon representing the type and/or the size of cooking vessel on which the cooking management device is positioned, the type and/or the size of the cooking vessel being recognized by the recognition system.

Preferably, it includes a switching-on device, the recognition system being activated when switching-on takes place.

Such an arrangement makes it possible, each time the cooking management device is switched on, to redetect the type and/or the size of the cooking vessel and thus, to guarantee that the signals emitted by the cooking management device are adapted to the type and/or the size of the cooking vessel on which it is installed.

Advantageously, it includes connection means, in particular pads, connected to the recognition system, the connection means being intended to cooperate with an electrical component positioned on the cooking vessel, in particular a temperature sensor or a resistor.

Thus, the recognition system is connected electrically and removably to an electrical component positioned on the cooking vessel which has a characteristic specific to the type and/or the size of the cooking vessel.

Such an arrangement also permits the cooking management device to adapt the signals emitted according to the measurements taken on the sensor.

Preferably, power values and/or curves according to the type and/or size of the cooking vessel are stored in the memory, the signals emitted being power setpoints.

Such an arrangement makes it possible to adapt the power setpoint signals emitted according to the type and/or the size of the cooking vessel recognized.

The invention also concerns a set formed of at least one cooking vessel and a cooking management device as described above.

Advantageously, the cooking vessel includes a handle, the cooking management device being positioned on the handle.

It is understood that the handle may be a long handle positioned on a frying pan or a loop handle positioned on a saucepan or a Dutch oven

Such an arrangement makes it possible to produce in an economic manner a cooking management device which can be installed on a set of cooking vessels. In fact, in a range of cooking vessels of different sizes, the handle is identical for each size. In addition, the area where the cooking management device is attached to the handle is identical for each cooking vessel.

Preferably, the cooking vessel includes an electrical component presenting an electrical characteristic R1 defining the type and/or the size of the cooking vessel, the recognition system being adapted to measure the electrical characteristic R1 in order to recognize the type and/or the size of the cooking vessel.

Advantageously, the electrical component is formed of an electrical resistor and/or a temperature sensor, in particular a thermocouple, and the electrical characteristic is a resistance value.

Such an arrangement makes it possible to obtain a very economical cooking management device. An electrical resistor is in fact a standard component, of low cost. The use of the temperature sensor, in particular of a thermocouple equipping the cooking vessel, does not make use of a particular component to detect the type and/or the size of this cooking vessel and is thus particularly economical.

Preferably, the vessel includes a mechanical component presenting a mechanical characteristic C1 defining the type and/or the size of the cooking vessel, the recognition system being adapted to measure the mechanical characteristic C1 in order to recognize the type and/or the size of the cooking vessel.

Such an arrangement makes it possible to obtain a reliable and long-lasting cooking management device.

Advantageously, the mechanical component is formed of at least one pad, and the mechanical characteristic is the presence or absence of the pad.

Such an arrangement makes it possible, based on a limited number of pads, to obtain a large number of combinations, each combination characterizing a type and/or a size of cooking vessel.

The invention also concerns a set formed of a hot plate, at least one cooking vessel and a cooking management device as described above.

The hot plate includes means for receiving the signals emitted by the cooking management device, the reception means acting on the means for control of the hot plate.

The invention also concerns a process of managing the cooking of a food placed in a food cooking vessel cooperating with a hot plate, the said cooking vessel including a cooking management device designed to emit signals intended either to control the hot plate or to prompt the user to act on the hot plate and/or on the food being cooked, characterized in that the process includes a step in which the cooking management device recognizes the type and/or size of the cooking vessel on which it is positioned, said cooking management device including a recognition system acting on the cooking management device in order to adapt the signals emitted according to the type and/or size of the cooking vessel recognized.

The invention will be more fully understood in consideration of the embodiments, which are in no way restrictive, illustrated in the attached figures, in which:

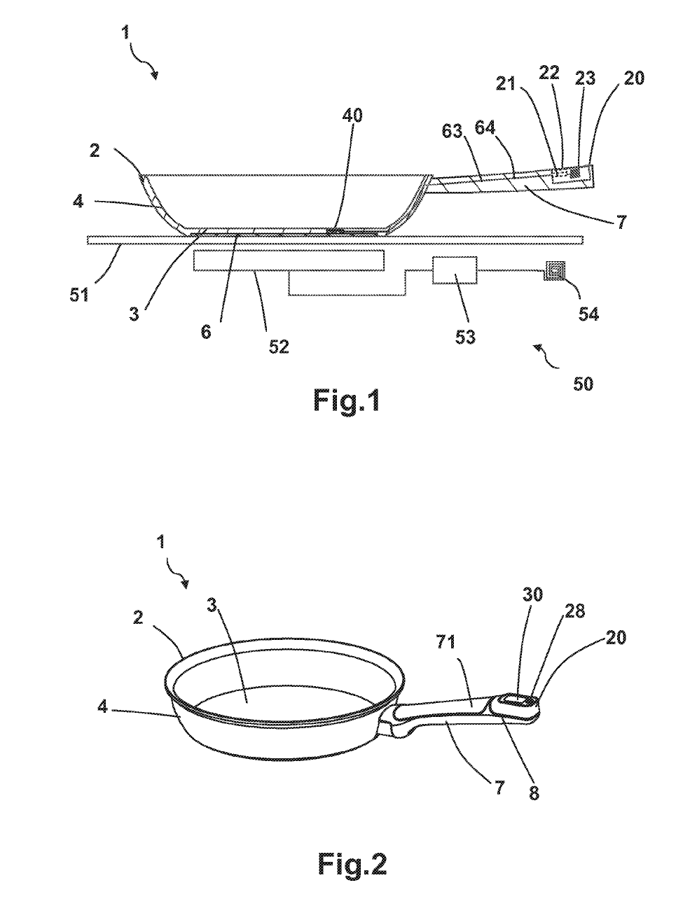

FIG. 1 illustrates a schematic sectional view of a cooking vessel resting on a hot plate and including a cooking management device according to a particular embodiment of the invention.

FIG. 2 illustrates a perspective view of the cooking vessel including the cooking management device illustrated in FIG. 1.

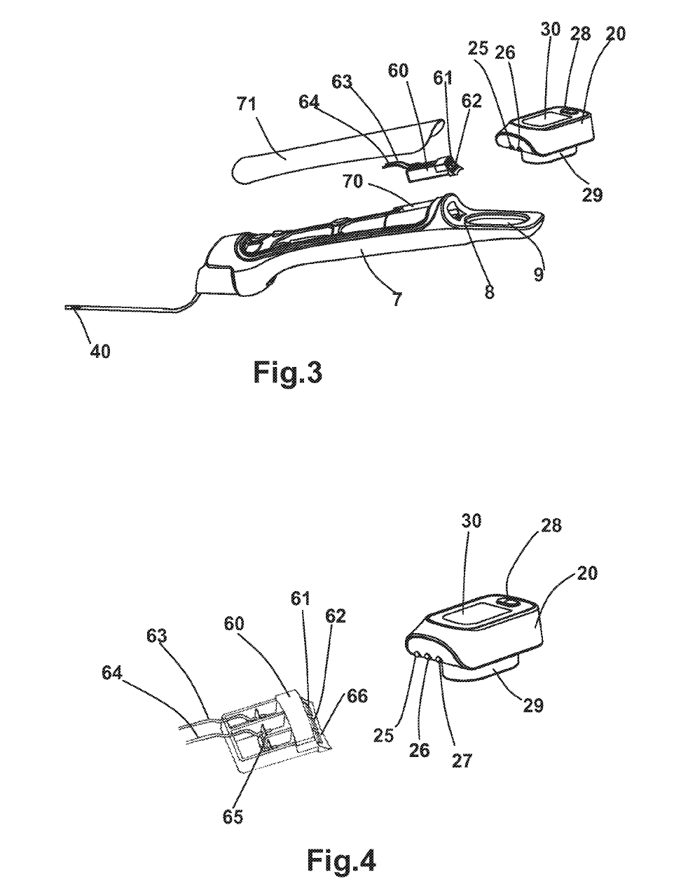

FIG. 3 illustrates an exploded perspective view of the handle of the cooking vessel including the cooking management device illustrated in FIG. 2.

FIG. 4 illustrates a partial exploded perspective view of the handle of the cooking vessel including the cooking management device illustrated in FIG. 3 according to a variant of the invention.

As seen in FIGS. 1 to 3, a cooking vessel 1 includes a bowl 2 which includes a bottom 3 and a side wall 4. The bowl 2 is made of a non-magnetic material, in particular of aluminum, for example by striking a disk or by casting. The bottom 3 presents a thickness in which is inserted a temperature sensor 40, in particular a thermocouple. The cooking vessel 1 includes a handle 7 in which is removably positioned a cooking management device 20. The cooking management device 20 is connected, for example electrically, to the temperature sensor 40 in order to receive information representing the temperature of the bottom 3.

The cooking vessel 1 rests on a hot plate 50, in particular with electric heating resistors or an induction hot plate which includes a glass ceramic plate 51, a heating device 52, in particular a hot pot or an inductor and a control device 53. The bottom 3 of the bowl 2 includes a component 6 made of ferromagnetic material intended, for example, to cooperate with the indicator of the heating device 52 to heat the cooking vessel 1. The component 6 made of a ferromagnetic material takes the form of a plate which is added in order to cover the temperature sensor 40.

The cooking management device 20 includes a radio transmitter 23, in particular a Bluetooth® transmitter, to emit signals intended to control the hot plate 50, in particular based on information received from the temperature sensor 40. The control device 53 of the hot plate 50 includes a receiver 54 to receive the signals emitted by the cooking management device 20 to control the hot plate 50. The signals emitted are, for example, power setpoints to be provided by the heating device 52 to the cooking vessel 1.

The cooking management device 20 includes a system 21 to recognize the type and the size of the cooking vessel on which it is positioned. The recognition system 21 acts on the cooking management device 20 in order to adapt the signals emitted according to the type and size of the cooking vessel 1 recognized.

The cooking management device 20 is intended to cooperate with different types and sizes of cooking vessels, each one including a temperature sensor 40, in particular a thermocouple with a specific resistance range characteristic of the type and size of the cooking vessel. The automatic recognition system 21 includes a memory 22 in which are stored the resistance value ranges, each value range being associated with a type and size of cooking vessel. The recognition system 21 is designed to detect the resistance value of the thermocouple and, based on the stored value ranges, each value range being associated with a type and a size of cooking vessel, to identify the type and size of the cooking vessel 1 on which it is positioned.

The cooking management device 20 includes an on/off button 28. Each time the device is switched on, the recognition system 21 is activated to detect the type and the size of the cooking vessel on which the cooking management device 20 is installed.

The cooking management device 20 is designed to adapt the signals emitted according to the type and size of the cooking vessel 1 recognized. The signals emitted, for example, the power setpoints to be provided by the heating device 52 to the cooking vessel 1, will be modulated by a stored coefficient corresponding to the type and the size of the cooking vessel 1.

As seen in FIG. 3, the handle 7 includes a cavity 70 in which is positioned a connector 60. The cavity 70 is closed with a cover 71. The connector 60 is equipped with a first contact area 61 and a second contact area 62. The first contact area 61 and second contact area 62 are connected to the temperature sensor 40 by two conductive parts 63, 64. The cooking management device 20 includes a first pad 25 and a second pad 26 connected to the recognition system 21 and intended to cooperate with the first contact area 61 and second contact area 62. The handle 7 includes a housing 8 equipped with a through opening 9. The cooking management device 20 includes a foot 29 intended to cooperate with the through opening 9 in order to keep the cooking management device 20 on the handle 7, as well as the first pad 25 and second pad 26 in contact with the first contact area 61 and second contact area 62. The foot 29 may hold a supply battery (not shown in the figures) of the cooking management device 20.

Advantageously, the through opening 9 is intended to form a ring for hanging up the cooking vessel 1.

In one variant, the cooking management device 20 includes a display 30 to prompt the user to act on the hot plate 50 or on the food being cooked. The display 30 may, for example, display a heating power setpoint that the user is prompted to read in order to then modify the setting of the hot plate 50. The recognition system 21 acts on the cooking management device 20 to adapt the heating power setpoint displayed according to the type and size of the cooking vessel 1 recognized. Advantageously, the cooking management device 20 includes audio means, in particular a buzzer (not represented in the figures) to alert the user and prompt the user to look at the display 30.

In another variant illustrated in FIG. 4, the cooking management device 20 is intended to cooperate with different types and sizes of cooking vessels, each one including a resistor 65 with a specific resistance value which will be characteristic of the type and size of the cooking vessel. The recognition system 21 includes a memory 22 in which are stored the resistance values, each one being associated with a type and size of cooking vessel. The recognition system 21 is designed to detect the resistance value of the resistor and, based on the stored resistance value ranges, each value range being associated with a type and a size of cooking vessel, to identify the type and size of the cooking vessel. The connector 60 includes a third electrical contact area 66 and the resistor 65 is connected to the second contact area 62 and the third contact area 66. The cooking management device 30 includes a third pad 27 connected to the recognition system 21 and intended to cooperate with the third contact area 66.

During use, the user chooses a cooking vessel 1 adapted to the size and/or type of food the user wishes to prepare, and the user fits the cooking management device 20 onto this cooking vessel. The user then turns on the cooking management device 20, which activates the automatic recognition system 21 which detects the resistance value of the temperature sensor 40. The recognition system 21 then determines the type and the size of the cooking vessel on which it is positioned, based on the value ranges stored in its memory 22, each value range being associated with a type and size of cooking vessel. The user then places the cooking vessel 1 on the hot plate 50 that the user has previously switched on. During food preparation, the food cooking management device 20 will emit power setpoints to be provided by the heating device 52 to the cooking vessel 1, which will be modulated by a stored coefficient corresponding to the type and the size of the cooking vessel 1.

For example, the cooking management device 20 includes a “simmer” function. For example, when preparing 4 servings of beef bourguignon in a saucepan appropriate for such a preparation, i.e., a saucepan 20 centimeters in diameter, the power setpoint to be provided by the heating device 52 to the saucepan, emitted by the cooking management device 20 in order to perform a simmer, is 330 watts. If the cooking management device 20 is positioned on a saucepan 16 centimeters in diameter, the applicant has demonstrated that the quantity of food prepared was less than at least one half of the quantity prepared in a saucepan 20 centimeters in diameter. Thus, for the “simmer” function in a saucepan 16 centimeters in diameter, the power setpoint to be provided by the heating device to the saucepan, emitted by the cooking management device, is 215 watts.

In one variant, the food cooking management device 20 will emit a signal corresponding to the type and size of the cooking vessel 1 which will be saved by the control device 53 of the hot plate 50, as well as information representing the temperature of the bottom 3. The control device 53 includes power setpoints to be provided by the heating device 52 to the cooking vessel 1, which will be modulated by a saved coefficient corresponding to the type and the size of the cooking vessel 1.

Of course, the invention is in no way limited to the embodiments described and illustrated, which have been provided only as examples. Modifications are still possible, in particular from the point of view of composition of the various components or by substitution of equivalent techniques, without departing from the scope of protection of the invention.

Thus, in one variant, the cooking management device 20 is positioned on an accessory of the cooking vessel 1, in particular a lid. The recognition system 21 detects the size of the accessory on which it is positioned, the size of the accessory corresponding to a size of cooking vessel.

1. A food cooking management device configured to be removably positioned on a cooking vessel cooperating with a hot plate, the cooking management device being configured to emit signals intended either to control the hot plate or to prompt the user to act on the hot plate and/or on the food being cooked, wherein the cooking management device includes a recognition system to recognize a type and/or size of the cooking vessel on which the cooking management device is positioned, said recognition system acting on the cooking management device in order to adapt the signals emitted according to the type and/or size of the cooking vessel recognized.

2. The food cooking management device according to claim 1, wherein the recognition system includes a memory in which is stored a table including value ranges of a characteristic of the cooking vessel, each value range being associated with a type and/or size of cooking vessel and wherein the recognition system is configured to detect a value of the characteristic of the cooking vessel and to deduce from said value the type and/or the size of the cooking vessel on which the cooking management device is installed based on the value ranges stored in the memory.

3. The food cooking management device according to claim 1, further comprising a radio transmitter configured to emit the signals intended either to control the hot plate or to prompt the user to act on the hot plate and/or act on the food being cooked.

4. The food cooking management device according to claim 1, further comprising a display and/or audio means in order to prompt the user to act on the hot plate or on the food being cooked.

5. The food cooking management device according to claim 1, further comprising a switching-on device, the recognition system being activated when switching-on takes place.

6. The food cooking management device according to claim 2, further comprising a connection system connected to the recognition system, the connection system being configured to cooperate with an electrical component positioned on the cooking vessel.

7. The food cooking management device according to claim 2, wherein power values and/or curves according to the type and/or size of the cooking vessel are stored in the memory, the signals emitted being power setpoints.

8. A set formed of at least one cooking vessel and a cooking management device according to claim 1.

9. The set according to claim 8, wherein the cooking vessel includes a handle, the cooking management device being positioned on the handle.

10. The set according to claim 8, wherein the cooking vessel includes an electrical component presenting an electrical characteristic defining the type and/or the size of the cooking vessel, the recognition system being adapted to measure the electrical characteristic in order to recognize the type and/or the size of the cooking vessel.

11. The set according to claim 10, wherein the electrical component is formed of an electrical resistor or a temperature sensor and wherein the electrical characteristic is a resistance value.

12. The set according to claim 8, wherein the cooking vessel includes a mechanical component presenting a mechanical characteristic defining the type and/or the size of the cooking vessel, the recognition system being adapted to measure the mechanical characteristic in order to recognize the type and/or the size of the cooking vessel.

13. The set according to claim 12, wherein the mechanical component is formed of at least one pad, and wherein the mechanical characteristic is the presence or absence of the pad.

14. A set formed of a hot plate, at least one cooking vessel and a cooking management device according to claim 1.

15. A process of managing the cooking of a food placed in a food cooking vessel cooperating with a hot plate, the cooking vessel including a cooking management device configured to emit signals intended either to control the hot plate or to prompt the user to act on the hot plate and/or on the food being cooked, the process comprising a step in which the cooking management device recognizes the type and/or size of the cooking vessel on which the cooking management device is positioned, said cooking management device including a recognition system which acts on the cooking management device in order to adapt the signals emitted according to the type and/or size of the cooking vessel recognized.

16. The food cooking management device according to claim 2, wherein said characteristic is an electrical and/or mechanical and/or optical characteristic.

17. The food cooking management device according to claim 3, wherein the radio transmitter is a Bluetooth® transmitter.

18. The food cooking management device according to claim 6, wherein the electrical component positioned on the cooking vessel is a temperature sensor or a resistor.

19. The set according to claim 11, wherein the electrical component is a thermocouple.
